(19) United States
(12) Patent Application Publication
(10) Pub. No.: US 2007/0222412 A1
(43) Pub. Date: Sep. 27, 2007

(54) DEVICE AND METHOD FOR THE AUTOMATIC REGULATION OF THE CHARGING OF AN ELECTROCHEMICAL GENERATOR

(75) Inventors: Serge Maloizel, Trois Palis (FR); Antoine Juan, Dirac (FR)

Correspondence Address: SUGHRUE MION, PLLC, 2100 PENNSYLVANIA AVENUE, N.W., SUITE 800, WASHINGTON, DC, 20037, US

(73) Assignee: SAFT, Bagnolet (FR)

(21) Appl. No.: 11/383,848

(22) Filed: May 17, 2006

(30) Foreign Application Priority Data
Mar. 21, 2006 (FR) 0602443

(51) Int. Cl. H02J 7/00

(52) U.S. Cl. 320/104

(57) ABSTRACT

A device controlling the charging of at least one electrochemical generator (1) comprises means (3, 4) of measuring the current passing through the electrochemical generator, means (5, 6, 7) of integrating the measured current, means (5, 8) of comparing the value of the integrated current with an index value (9) and means (2) of interrupting the passage of the current into the electrochemical generator when the integrated current reaches the index value.

A device controlling the charging of a plurality of electrochemical generators, comprising at least two sets of electrochemical generators (1) connected in parallel to a charger, each connection of a set to the charger comprising a branch of the circuit equipped with the device according to the invention. This control device does not need a system of communication between the branches of the circuit.

### BACKGROUND OF THE INVENTION

The invention relates to the field of devices controlling the charging of an electrochemical generator. More specifically, the invention relates to the field of devices controlling the charging of one or more electrochemical generators connected in a parallel circuit to a charging device.

The control (or automatic regulation) devices may control the charging and discharging status of an electrochemical generator, but also its temperature and/or the current passing through crossing it. Each electrochemical generator may be discharged to supply the electrical energy required for a given application, for example an electric vehicle. The electrochemical generator may also be connected to a charging device to increase the electrical energy stored.

The state of charge of an electrochemical generator is monitored permanently in order to ensure that it is not subjected to an overcharging that may lead to a thermal runaway and its destruction.

The state of overcharge of an electrochemical generator of lithium ion type can easily be detected. The voltage of an electrochemical generator of lithium ion type reflects its charge status. This is not the case for an electrochemical generator of nickel metal-hydride type, in which the voltage during charging does not reflect its state of charge.

In order to avoid overcharging of an electrochemical generator of nickel metal-hydride type, the charging voltage must be controlled, especially in the case where several generators are connected in parallel to a charger.

Electrochemical generators are not always available in the desired electric capacity. Several electrochemical generators are then connected together in a parallel circuit in order to increase the electrical capacity required for the operation of a given application. The internal resistance of an electrochemical generator may vary from one generator to another, and therefore the charging current may vary according to the parallel branches of the circuit, which requires the provision of a relatively sophisticated charging management device. Such a device must be suitable for regulating the charging current in each of the branches of the parallel circuit in order to compensate for the variations in internal resistance of each branch of the circuit.

The solution currently used requires the use of control devices for each branch which intercommunicate. The charger current is firstly received by a first branch, then by a second branch and so on up to branch No. n, then reverting to the first branch. Switching from branch to branch is via a communication device between the devices of each branch.

In order to function correctly, the regulator device requires reliable communication between the branches.

Moreover, the addition of a branch when one or more supplementary electrochemical generators are connected in parallel requires each control device to be informed of the presence of the supplementary branch.

Therefore a regulating device is sought that allows a regulation of the charging of the electrochemical generator(s) of each branch of the parallel circuit, which is either suitable for automatically regulating the current in each branch, independently of the addition of a supplementary branch, or the removal of one or more of the branches.

A charging-control device is also sought which does not use an inter-branch communication device.

### SUMMARY OF THE INVENTION

To this end, the invention proposes a device for controlling the charging of at least one electrochemical generator, comprising a device for measuring the current passing through crossing the electrochemical generator; a device for integrating the measured current; a device for comparing the value of the integrated current with an index value; a device for interrupting the passage of the current into the electrochemical generator when the integrated current reaches the index value.

According to an embodiment, the device for measuring the current comprises a resistor in series with the electrochemical generator, and an amplifier connected to the terminals of the resistor.

According to an embodiment, the device for integrating the current is a computer, also suitable for comparing the value of the integrated current with an index value and ordering the interruption of the passage of the current into the electrochemical generator when the integrated current reaches the index value.

The invention also relates to a device controlling the charging of a plurality of electrochemical generators, comprising at least two sets of electrochemical generators connected in parallel to a charger, each connection of a set to the charger comprising a branch of the circuit equipped with a device for measuring the current passing through said branch of circuit; a device for integrating the measured current; a device for comparing the value of the integrated current with an index value; a device for interrupting the passage of the current into said branch of circuit when the integrated current reaches the index value.

According to a characteristic, the device controlling the charging of a plurality of electrochemical generators does not include a communication device between the branches of the circuit, suitable for diverting the current from one branch of the circuit to another branch of the circuit.

The invention also relates to a rechargeable battery comprising at least one electrochemical generator and a charge control device for controlling the charging of said at least one electrochemical generator, said charge control device comprising a device for measuring the current passing through the electrochemical generator; a device for integrating the measured current; a device for comparing the value of the integrated current with an index value; a device for interrupting the passage of the current into the electrochemical generator when the integrated current reaches the index value.

According to a characteristic, each electrochemical generator has an alkaline electrolyte. Each generator is preferably of nickel metal-hydride type.

The invention also relates to a method of controlling the charging of at least one electrochemical generator, comprising the stages of:
measuring the current passing through the electrochemical generator;
integrating the current;
comparing the value of the integrated current with an index value;
interrupting the passage of the current into the generator when the integrated current reaches the index value.

### BRIEF DESCRIPTION OF THE DRAWINGS

Other characteristics and advantages of the invention will appear on reading the following detailed description of the embodiments of the invention, given by way of example only and with reference to the drawings showing:

FIG. 1 schematically illustrates the charging-control device according to the invention.

FIG. 2 shows the variation in the charging current in the generator and variation in the integrated current in relation to time.

FIG. 3 shows the distribution of the charging currents in two branches of the parallel circuit with the charging-control device according to the invention.

FIG. 4 shows a possible variant implementation of the charging-control device according to the invention.

### DETAILED DESCRIPTION OF PREFERRED EMBODIMENTS

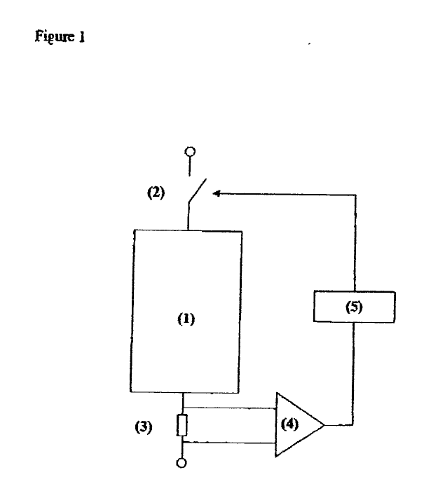

The operation of the charging-control device will now be described with reference to FIG. 1. The unit (1) is a set of electrochemical generators (1) of which it is desired to regulate the charging current. This set of electrochemical generators comprises one or more electrochemical generators, regardless of their mode of interconnection. The electrochemical generators may be those which have an alkaline electrolyte, and more preferably those of nickel metal-hydride type.

The charging-control device comprises the following elements:
a switch (2) arranged in series with the set of electrochemical generators. It may for example be positioned between one of the terminals of the charger and one of the polarities of the set of electrochemical generators. Its function is to stop the passage of the current into the set of electrochemical generators. Its opening/closing is ordered by a computer (5).
means (3, 4) of measuring the current passing through the set of electrochemical generators. This current measurement means may comprise a resistor placed in series with the set and an amplifier (4). The function of the resistor (3) is to permit an indirect measurement of the charging current passing through the set of electrochemical generators. The amplifier (4) comprises input channels connected to the terminals of the current-measurement means (3). An output channel is connected to the input of the computer (5) which integrates the value of the current passing through the resistor (3). The current measurement means may also comprise any system allowing a current to be transformed into a voltage, such as a Hall effect sensor, a closed-loop sensor or a magnetic detection sensor.

The computer (5) also comprises a device for comparing the value of the integrated current with an index value. When the value of the integrated current reaches the index value, the computer orders the switch (2) to open and keeps it open for a certain period of time, which has the effect of temporarily interrupting the charging of the set of electrochemical generators during this period of time. When this period of time has elapsed, the computer orders the switch to close and charging resumes. Thus the charging current is regulated to the desired value.

The principle of the regulation is based on the fact that the computer adjusts the closure and opening periods of the switch in relation to the current measured and the average current which it is desired to pass across the set of generators for an optimum charging of the set of electrochemical generators. The average current is fixed by the user according to the characteristics of the set of electrochemical generators (capacity, surface of the electrodes, etc.).

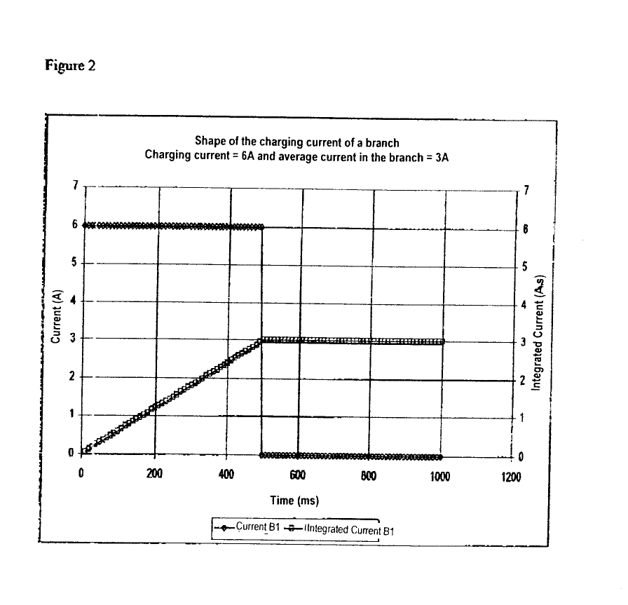

Using an example, FIG. 2 shows the variation in the charging current in a set of electrochemical generators and the variation in the integrated current in relation to time (equivalent to a quantity of electricity).

Let us suppose that the set of electrochemical generators must be recharged at an average current of 3 A, and that the charger delivers a charging current of 6 A. The charger current is greater than the desired average current: it is therefore necessary to regulate the charging current to avoid overcharging the set of electrochemical generators.

At time t=0, the switch (2) is closed. A 6 A current is delivered.

From time t=0 to time t<500 ms, the computer integrates the current and compares the value of the integrated current with the predetermined value of 3 A.s. For as long as the integrated current is below 3 A.s, the switch remains closed.

At t=500 ms, the computer detects that a quantity of electricity of 3 A.s has that has passed through the set. The index value for the quantity of electricity that has passed through the set is reached. The computer orders the switch to open until t=1s.

At t=1s, the computer orders the switch to close, and charging resumes.

For a period of one second, the average current delivered is indeed 3 A as the switch has remained open for half the period.

The device according to the invention is therefore well suited to those cases where the charger may deliver a current which is too strong compared with the desired charging current. In addition, the charging of the generator adapts automatically to any source of supply.

The invention also relates to a device controlling the charging of a plurality of sets of electrochemical generators. These sets may be connected in parallel to a charger. Each connection of a set of generators to the charger forms a branch of the circuit. Each branch is equipped with a charging-control device according to the invention.

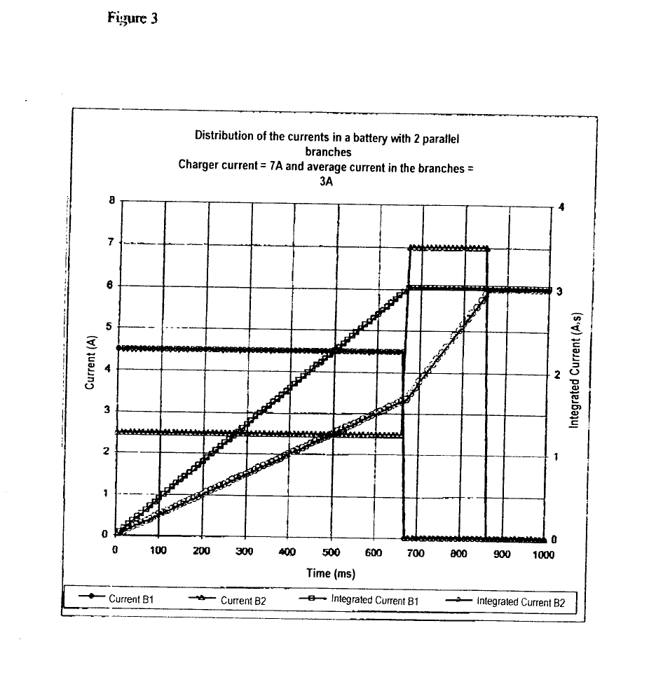

FIG. 3 uses an example to show the variation in relation to time of the charging current of two sets of electrochemical generators connected to two parallel branches, together with the variation in the integrated current in relation to time.

In this example, the charger delivers 7 A to two branches in parallel, each equipped with a device according to the invention, and it is desired to charge each branch at an average current of 3 A.

Let us suppose that at t=0s branch B1 receives a current of 4.5 A and that branch B2 receives a current of 2.5 A, as a result of an imbalance between these branches.

Branch 1: the computer of branch B1 keeps the switch of branch 1 closed from t=0 to t=0.667 s (0.667=3/4.5). For 0.667 s<t<1 s, the switch of branch 1 is kept open.

Branch 2: from t=0 to t=0.667 s, the current passing through branch B2 is 2.5 A. At t>0.667 s, the current passing through branch B2 increases from 2.5 A to 7 A as a result of the opening of the switch of branch B1. The switch of branch B2 then remains closed for 0.191 s. The computer of branch B2 keeps the switch of branch B2 closed for a total of 0.858 s.

The quantity of electricity which has passed through branch B2 during one second is therefore indeed 3 A.s, if the calculation is carried out (2.5×0.667+7×0.191=3).

In order to distinguish between the charging, balancing or maintenance currents, it is enough for each computer of each branch to modify the closure period of its switch.

One of the advantages of the device according to the invention is that each branch automatically regulates the current passing through it.

Each branch has its own charging-control device, operating independently of the charging-control devices installed on the other branches of the circuit. The need for communication between the branches has thus been removed. Moreover, the addition of a supplementary branch does not disturb the operation of the other branches of the circuit. Thus, new sets of generators may be added to an electric supply system of a given application without the need to adjust the operation of the sets already present.

The device is well suited to the regulation of the current in the case where there is an “imbalance” between the branches of the circuit, i.e. branches having different currents passing through them.

In the example of FIG. 3, the sets of electrochemical generators are two in number. It is understood that the device of the invention is not limited to two sets but may comprise a larger number of sets.

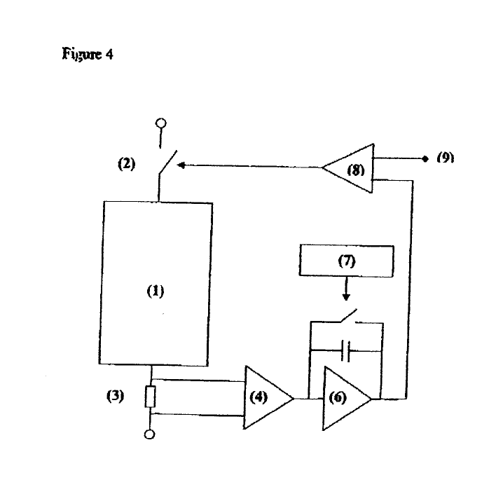

FIG. 4 represents a possible variant implementation of the charging-control device according to the invention, in which the computer is replaced by an analogue integrator (6) combined with a counter (7) and a comparator (8).

At t=0, the counter (7) reinitialises the integrator (6), which causes the closure of the switch (2); the current amplified by the amplifier (4) is then integrated by the integrator (6). When the output signal of the integrator (6) reaches the index value (9), the output of the comparator (8) trips, causing the switch (2) to open and the charging current to stop. After a certain period of time during which the switch remains open, charging resumes. Thus an operation is achieved that is identical to that described with reference to FIG. 1.

This invention is not, of course, limited to the embodiments described by way of example: thus the computer of each branch will equally be able to integrate the control functions for charge or discharge phases, combining with same devices for measuring the temperature of the branch and measuring the voltage of the branch or sub-sets of the branch.

1. Device for controlling the charging of at least one electrochemical generator, comprising:
a device for measuring the current passing through the electrochemical generator;
a device for integrating the measured current;
a device for comparing the value of the integrated current with an index value;
a device for interrupting the passage of the current into the electrochemical generator when the integrated current reaches the index value.

2. Device according to claim 1, in which the device measuring the current device comprises a resistor in series with the electrochemical generator, and an amplifier connected to the terminals of the resistor.

3. Device according to claim 1, in which the device for integrating the current is a computer also suitable for comparing the value of the integrated current with an index value and ordering the interruption of the passage of the current into the electrochemical generator when the integrated current reaches the index value.

4. Device for controlling the charging of a plurality of electrochemical generators, comprising at least two sets of electrochemical generators connected in parallel to a charger, each connection to a set to the charger comprising a branch of the circuit equipped with:
a device for measuring the current passing through said branch of circuit;
a device for integrating the measured current;
a device for comparing the value of the integrated current with an index value;
a device for interrupting the passage of the current into said branch of circuit when the integrated current reaches the index value.

5. Device according to claim 4, characterized in that it does not include a device for communication between the branches of the circuit, suitable for diverting the current from one branch of the circuit to another branch of the circuit.

6. Rechargeable battery comprising at least one electrochemical generator and a charge control device for controlling the charging of said at least one electrochemical generator, said charge control device comprising:
a device for measuring the current passing through the electrochemical generator;
a device for integrating the measured current;
a device for comparing the value of the integrated current with an index value;
a device for interrupting the passage of the current into the electrochemical generator when the integrated current reaches the index value.

7. Rechargeable battery according to claim 6, characterized in that the electrochemical generator has an alkaline electrolyte.

8. Rechargeable battery according to claim 7, characterized in that the electrochemical generator is of nickel metal-hydride type.

9. Method for controlling the charging of at least one electrochemical generator, comprising the stages of:
measuring the current passing through the electrochemical generator;
integrating the current;
comparing the value of the integrated current with an index value;
interrupting the passage of the current into the generator when the integrated current reaches the index value.

10. Device according to claim 2, in which the device for integrating the current is a computer also suitable for comparing the value of the integrated current with an index value and ordering the interruption of the passage of the current into the electrochemical generator when the integrated current reaches the index value.
